(19) United States
(12) Patent Application Publication
(10) Pub. No.: US 2020/0247488 A1
(43) Pub. Date: Aug. 6, 2020

(54) TRAVEL HEIGHT TRUSS AND METHODS OF USE

(71) Applicant: CW10K40 LLC, Camden, DE (US)

(72) Inventor: Torsten Leines, Maple Grove, MN (US)

(73) Assignee: CW10K40 LLC, Camden, DE (US)

(21) Appl. No.: 16/263,631

(22) Filed: Jan. 31, 2019

(51) Int. Cl. B62D 53/06; B62D 21/14; E21B 19/15

(52) U.S. Cl. CPC B62D 53/067; B62D 63/06; E21B 19/155; B62D 21/14

(57) ABSTRACT

Aspects of the disclosure relate to a trailer having a frame suitable for transporting an item. The trailer includes a boom which may be raised from the trailer and support cables used to move the pipe from the trailer to a storage or other location. The boom is raised and lowered by a hydraulic system comprising a travel height truss. The travel height truss may comprise two portions, pivotably connected to each other, one portion pivotably connected to the frame and the other pivotably connected to the boom. The travel height truss provides greater leverage than would otherwise be available for the maximum size and weight of the load available for a given (fixed) maximum length of trailer. In this manner, the boom frame can be raised to greater heights, while maintaining horizontal distance, than otherwise. Methods of use are also disclosed.

### BACKGROUND

Drilling rigs are known and used for identifying geologic reservoirs of natural resources, such as oil, for example, and also to create holes that allow the extraction of natural resources from those reservoirs. The extraction process begins by positioning the drilling rig over the site to be drilled. Drilling rigs can be mobile and driven from site to site or can also be more permanent structures positioned over the drilling site.

The process begins by drilling a hole deep into the Earth. A long drill bit attached to a section of “drilling string” is used for this purpose. After each section is drilled, a steel pipe slightly smaller than the hole diameter is dropped in and often cement is used to fill the outer gap. The steel pipe is called a casing and provides structural integrity to the drilled hole. As the drill bit progresses deeper, additional sections of pipe need to be added to the drilling string to allow the drill bit to move further into the Earth. Typically, workers standing on the drilling rig take the additional sections of pipe, one by one, and screw them onto the drilling string, as needed. The additional sections of pipe are delivered to the site and then raised one by one to the workers with a crane. Currently, oil rigs are accessed by workers from the ground with a step ladder.

The present disclosure addresses problems and limitations with the related art.

### SUMMARY

Aspects of the disclosure relate to a trailer having a frame for supporting and transporting a section of pipe or other item. The trailer includes a boom which may be raised from the trailer and used to move the pipe to or from the trailer to a storage or other location. For example, index arms may move the pipe from a ground storage rack to the boom, where a skate may push the pipe along the length of the boom toward the rig. Or, the pipe may be moved from the rig to the boom, where the skate allows controlled downward movement of the pipe to where the pipe may be moved from the boom back onto ground storage racks. The boom is raised and lowered by a hydraulic system comprising a travel height truss. The travel height truss may comprise two portions, pivotably connected to each other, one portion pivotably connected to the frame and the other pivotably connected to the boom. Two independently controllable hydraulic cylinders control the motion of the travel height truss. The travel height truss provides greater leverage to the boom than would otherwise be available for the maximum size and weight of the boom available for a given (fixed) maximum length of trailer. In some embodiments, the combination of the travel height truss and a lift assist assembly allows the boom to reach higher rig heights while maintaining a horizontal distance from the rig.

Embodiments of the disclosure are particularly useful for raising booms used to lift pipe sections used in oil drilling. In such embodiments, the frame can be driven to a job site, and the boom extended to its full height to enable movement of the pipe sections or other items up or down the boom. Embodiments of the disclosure provide a safe and stable, yet more versatile trailer because they permit the boom to raise the pipe sections to greater heights, while maintaining horizontal distance, than trailers without the inventive features.

In one aspect, the disclosure provides a trailer comprising a frame having opposing first and second sides as well as an axle supporting a plurality of wheels. The trailer includes a boom which may be raised from the trailer and used to move the pipe from the trailer to a storage or other location. The boom is raised and lowered by a hydraulic system comprising a travel height truss. The travel height truss may comprise two portions, pivotably connected to each other, one portion pivotably connected to the frame and the other pivotably connected to the boom. Two independently controllable hydraulic cylinders control the motion of the travel height truss. One cylinder is pivotably connected between each of the two portions of the travel height truss, and the other cylinder is pivotably connected between one of the portions and the frame of the trailer.

In another aspect, the disclosure provides a method of operating a trailer including providing a trailer in a transport arrangement, the trailer having a frame with first and second sides as well as an axle supporting a plurality of wheels. In addition, the trailer includes a boom which may be raised from the trailer and is used to move the pipe from the trailer to a storage or other location. The boom is raised and lowered by a hydraulic system comprising a travel height truss. The travel height truss may comprise two portions, pivotably connected to each other, one portion pivotably connected to the frame and the other pivotably connected to the boom. Two independently controllable hydraulic cylinders control the motion of the travel height truss. One cylinder is pivotably connected between each of the two portions of the travel height truss, and the other cylinder is pivotably connected between one of the portions and the frame of the trailer.

### BRIEF DESCRIPTION OF THE DRAWINGS

The accompanying drawings are included to provide a further understanding of embodiments and are incorporated in and constitute a part of this specification. The drawings illustrate embodiments and together with the description serve to explain principles of embodiments. Other embodiments and many of the intended advantages of embodiments will be readily appreciated as they become better understood by reference to the following detailed description. Like reference numerals designate corresponding similar parts.

FIG. 1 is a perspective view of a frame portion of a trailer of the disclosure.

FIG. 2A is a side view of the trailer depicted in FIG. 1.

FIG. 2B is a bottom view of the frame portion of the trailer depicted in FIG. 1.

FIG. 2C is an end view of the frame portion of the trailer depicted in FIGS. 1 and 2A-2B.

FIG. 3A is a perspective view of the frame of FIGS. 1 and 2A-2C loaded with additional components according to the disclosure.

FIG. 3B is an enlarged view of a portion of FIG. 3A.

FIGS. 3C and 3D are enlarged side views of the loaded frame of FIG. 3A shown in alternative positions according to the disclosure.

FIGS. 3E and 3F are enlarged views of portions of FIGS. 3C and 3D, respectively.

FIG. 4A is another perspective view of a portion of a loaded trailer according to the disclosure.

FIG. 4B is an enlarged perspective view of the portion of FIG. 4A within dashed lines.

FIG. 5A is an enlarged side view of the loaded frame of FIG. 3A shown in an alternative position according to the disclosure.

FIG. 5B is an enlarged side view of a portion of the loaded frame of FIG. 5A.

FIG. 6 is a side cross-section of a portion of a loaded frame according to the disclosure.

### DETAILED DESCRIPTION

In the following detailed description, reference is made to the accompanying drawings, which form a part hereof, and in which is shown by way of illustration specific embodiments in which the disclosure may be practiced. In this regard, directional terminology, such as “top,” “bottom,” “front,” “back,” “leading,” “trailing,” etc., is used with reference to the orientation of the Figure(s) being described. Because components of embodiments can be positioned in a number of different orientations, the directional terminology is used for purposes of illustration and is in no way limiting. It is to be understood that other embodiments may be utilized and structural or logical changes may be made without departing from the scope of the present disclosure. The following detailed description, therefore, is not to be taken in a limiting sense, and the scope of the present disclosure is defined by the appended claims.

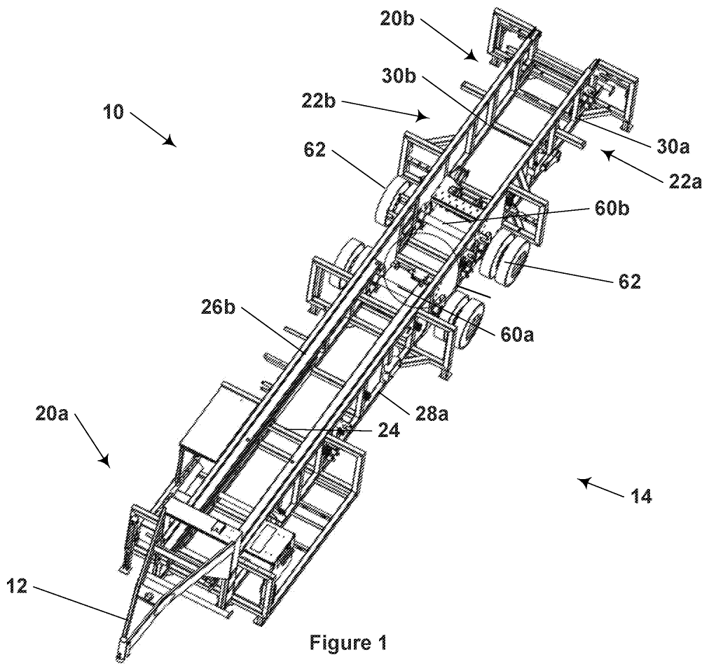

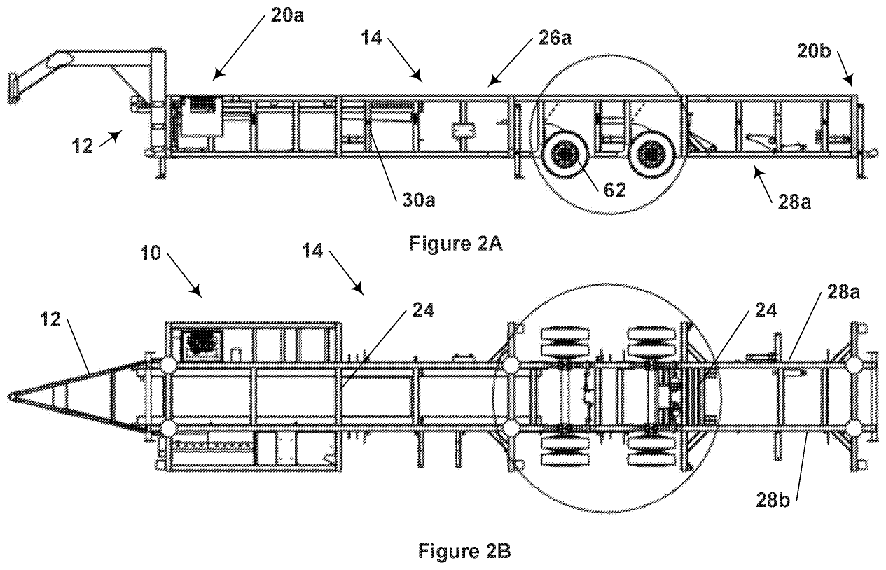

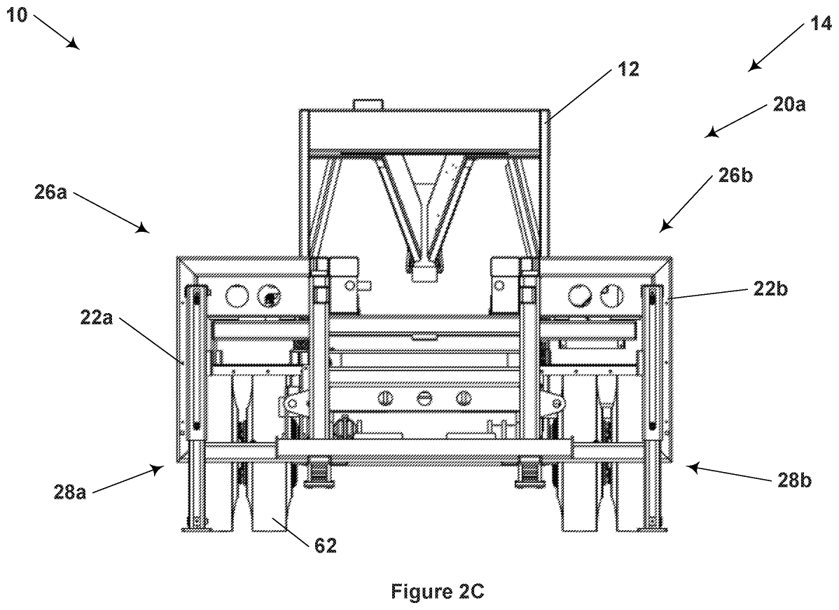

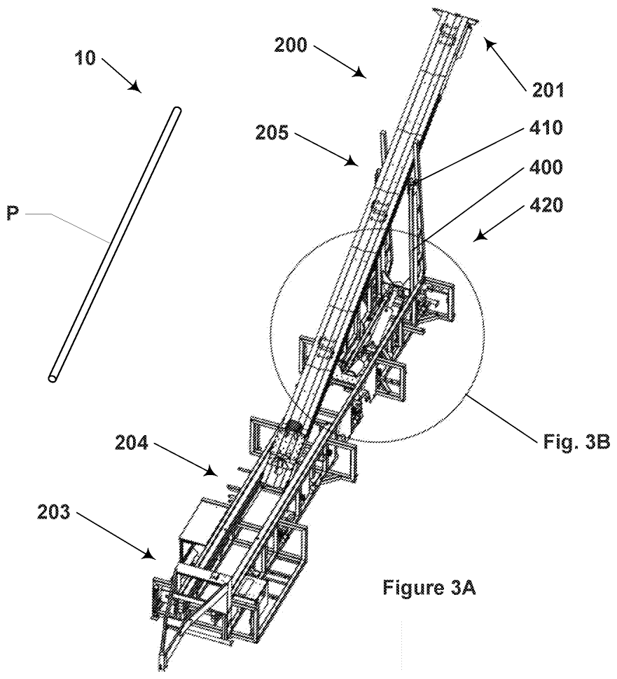

One illustrative trailer 10 is collectively illustrated in the figures. As shown there, and particularly referring to FIGS. 1 and 2A-2C, the trailer 10 includes a hitch 12 for securing to a vehicle (not shown), such as a truck, as well as a frame 14 interconnected to the hitch 12. The frame 14 can take a variety of forms, as desired, and supports an item to be transported. In particular, frame 14 preferably various loads omitted from FIGS. 1 and 2A-2C solely for clarity of illustration.

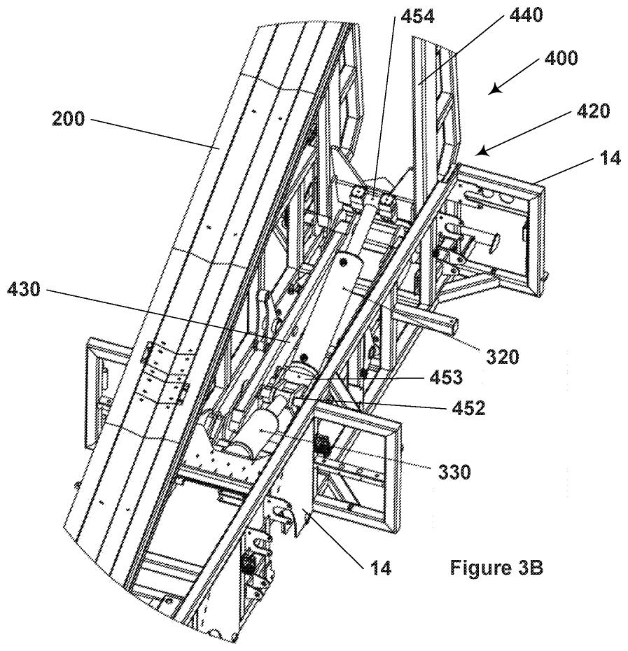

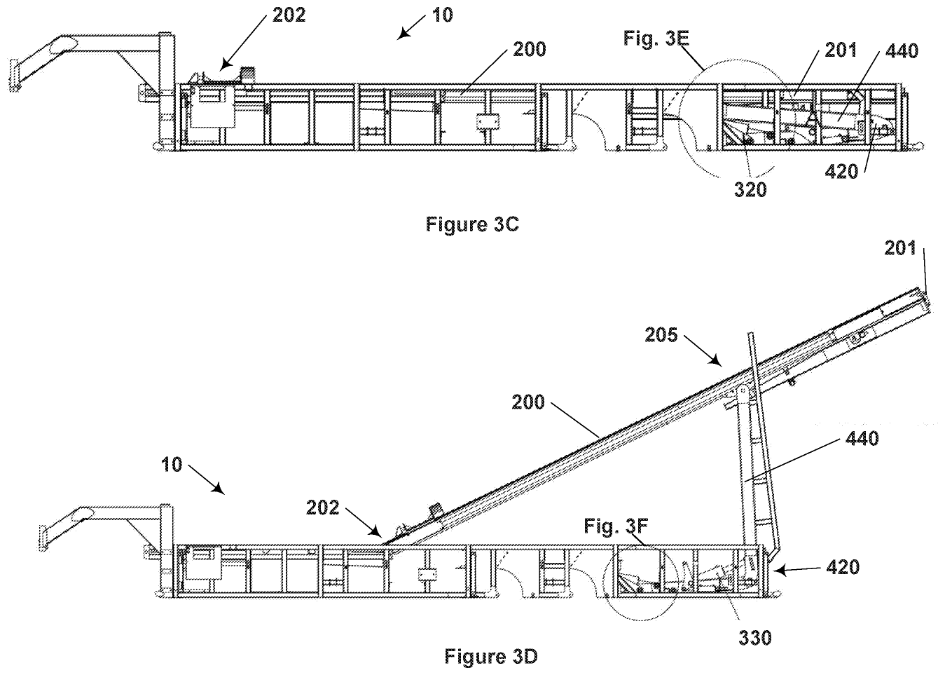

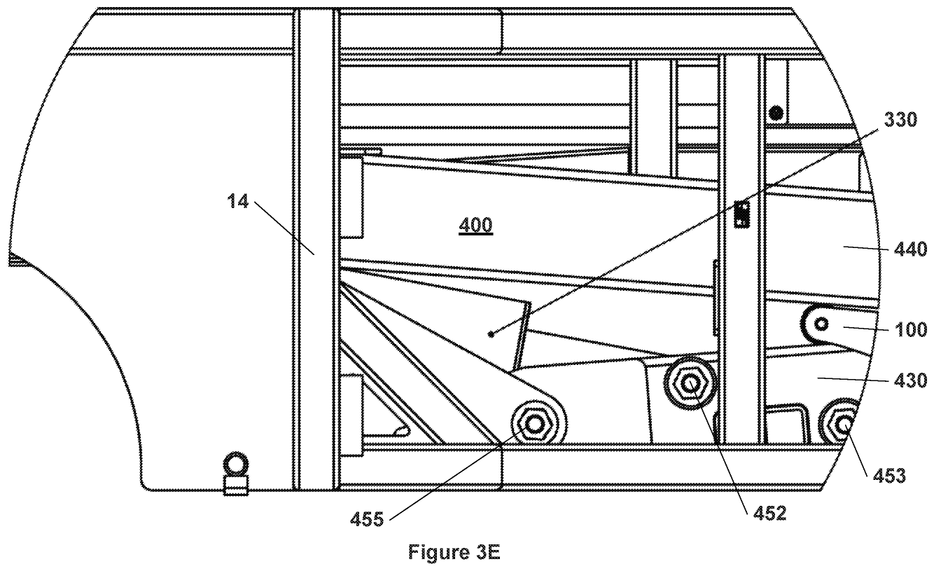

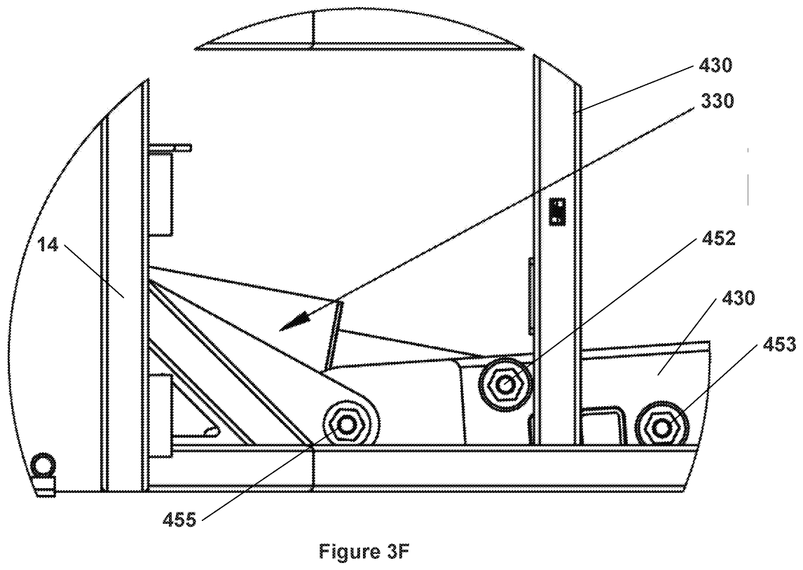

In one example, the item to be transported is a boom system usable to lift pipe sections suitable for oil drilling (e.g., pipe P in FIG. 3A). The frame 14 can, for example, include first and second ends 20a, 20b, first and second sides 22a, 22b, and multiple bottom supports 24 spanning the first and second sides 22a, 22b. Each side 22a, 22b can include a top 26a, 26b and a bottom 28a, 28b and include multiple vertical supports 30a, 30b spanning the respective top 26a, 26b and bottom 28a, 28b. It is noted that only a few representative horizontal supports 24 and vertical supports 30a, 30b are referenced for ease of illustration. The present disclosure, however, is not intended to be limited to any particular configuration of frame 14.

Interconnected to the frame 14 is at least one axle 60a, 60b operatively supporting at least one wheel 62 on opposing sides 22a, 22b of the frame 14 (e.g., four wheels connected to each axle, two on each side of the frame). The wheels 62 can be any type commonly used for trailers, trucks or the like. In the illustrated embodiment, the trailer 10 includes first and second axles 60a, 60b, each axle 60a, 60b supporting two wheels 62 on opposite sides 22a, 22b of the frame 14.

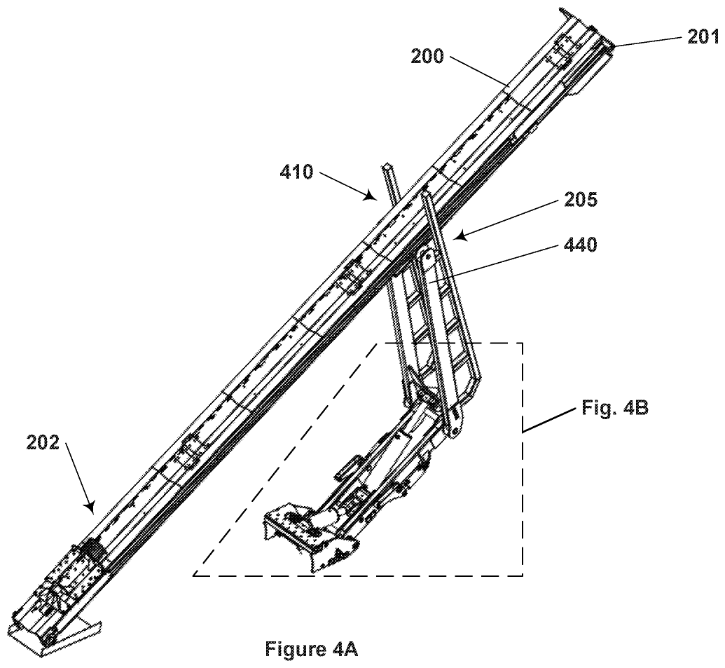

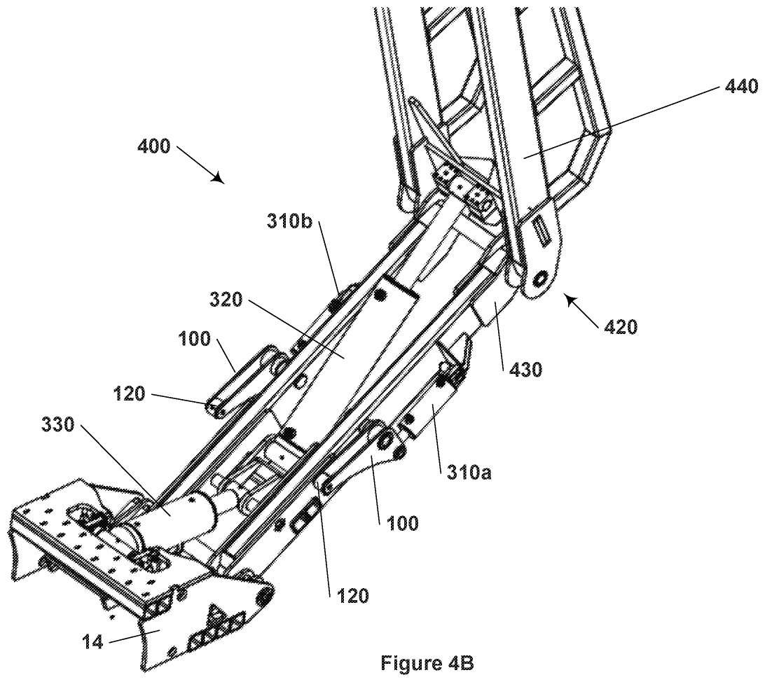

Turning now to FIGS. 3A-3A-3F, 4A-4B, and 5A-5B, trailer 10 has a frame 14 which supports a boom 200. Generally, boom 200 is telescopically or otherwise extendable to a length longer than that of the length of the frame 14, but this is not required. Such extension may be accomplished by any convenient means not critical to this disclosure. Further details of one extendable embodiment of the boom may be found in application Ser. No. 16/263,592 filed Jan. 31, 2019, copending, the disclosure of which is hereby incorporated by reference in its entirety.

In general, boom 200 is mounted to frame 14 so that a first portion 201 of boom 200 may be elevated substantially above trailer 10 and frame 14 while a second portion 202 remains generally in place vertically. To increase the angle above vertical which boom 200 may make with the generally horizontal plane of the frame 14, and thus increase the height to which the first portion 201 may reach for a given length of boom 200, the second portion 202 both pivots about an axis transverse to the length of frame 14, and translates from a forward position 203 to a rearward position 204.

Boom 200 is elevated from the frame 14 by the action of travel height truss 400. Like boom 200 itself, travel height truss 400 is mounted to frame 14 so that one end of it may pivot above frame 14. Thus, the forward end 410 of travel height truss 400 may be elevated substantially above frame 14 while the rearward end 420 may remain generally in place vertically, depending on the exact design of travel height truss 400. The forward end 410 is pivotably attached to boom 200 at a boom middle location 205. The angle above vertical which boom 200 makes with the generally horizontal plane of the frame 14 increases as the forward end 410 of travel height truss 400 is elevated above frame 14. The elevation of forward end 410 is accomplished by one or more hydraulic cylinders arranged to cause travel height truss 400 to move relative to frame 14.

It is desirable, but not required, to use a lift assist assembly 100 to help raise and lower the travel height truss 400. In general terms, the lift assist assembly 100 transfers force generated in a generally longitudinal direction to the vertical load of the travel height truss 400. The lift assist assembly 100 thus acts to lift the forward end 410 of the travel height truss 400 as the rearward end 420 of that truss 400 pivots in place. The depiction of two lift assist assemblies 100 in the figures is a preference and not a requirement. In another embodiment according to this disclosure but not illustrated here, any number of lift assist assemblies 100 could be employed provided the travel height truss 400 were appropriately modified to accommodate each lift assist assembly 100. In one preferred embodiment frame 14 is provided with a pair of lift assist assemblies 100, one such assembly on each opposing side 22a, 22b of the frame 14. The lift assist assembly 100 is described in greater detail in application Ser. No. 16/263,553 filed Jan. 31, 2019, copending, the disclosure of which is hereby incorporated by reference in its entirety.

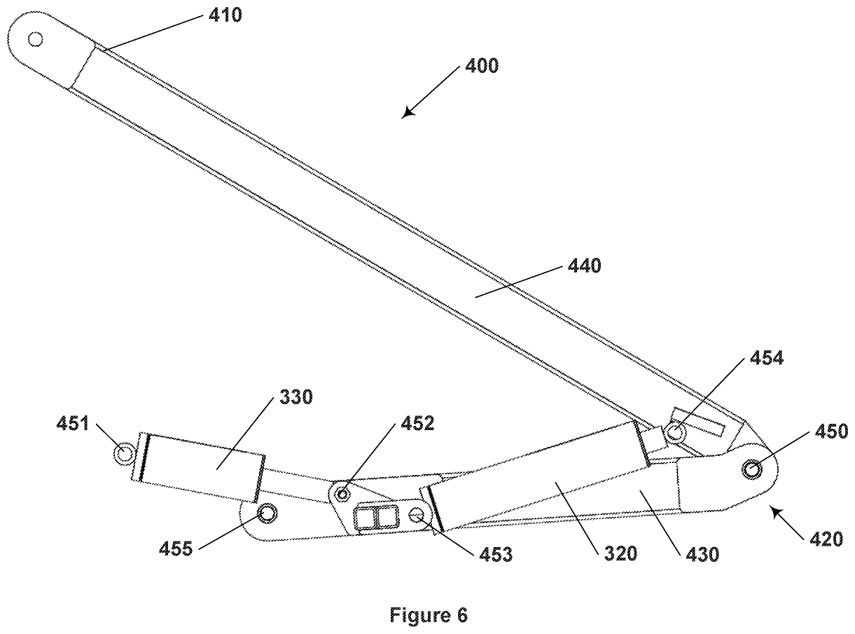

In the preferred embodiment illustrated (see also FIG. 6), the travel height truss 400 preferably comprises two components an inner frame 430 and an outer frame 440, pivotably attached to each other at hinge 450. The inner frame 430 as a whole may pivot with respect to frame 14 at hinge 455. When fully folded together, inner frame 430 is essentially folded inside and outer frame 440, and thus hinge 450 lies at the position corresponding to rearward end 420 as shown in FIG. 3C. In this position, the end of outer frame 440 opposite hinge 450 represents forward end 410, as best shown in FIG. 3A despite the boom 200 being slightly elevated.

Travel height truss 400 also may include one or more dual acting hydraulic cylinders to move the inner frame 430 and the outer frame 440 relative to each other and frame 14. In the preferred embodiment illustrated in the figures, travel cylinder 330 is pivotably connected between the frame 14 and the inner frame 430. An example of a suitable travel cylinder 330 is of the type having the following specifications: dual acting cylinder with an 8 inch bore, 12 inch stroke length, 5,000 psi rating, 2.5 inch diameter pins and 28 inch retract length. Specifically, travel cylinder 330 pivotably connects to frame 14 at lung 451 and to truss inner frame 430 at lug 452. Lug 452 is located on adjacent the hinge 455 which pivotably connects inner frame 430 to frame 14. Similarly, lift cylinder 320 is pivotably connected between the inner frame 430 and the outer frame 440. An example of a suitable lift cylinder 320 is of the type having the following specifications: dual acting cylinder having an 8 inch bore, 30 inch stroke length, 5,000 psi, 2.5 inch pin diameter and 46 inch retract length. Specifically, lift cylinder 320 pivotably connects to truss inner frame 430 at lug 453. Lug 453 is located on inner frame 430 adjacent to lug 452 and lug 454 is located on outer frame 440 adjacent the hinge 450 which pivotably connects inner frame 430 to outer frame 440.

Each cylinder 320, 330 acts to force the travel height truss 400 to move with the ultimate objective of lifting the forward end 410 of the travel height truss 400 as the rearward end 420 pivots in place relative to frame 14 at hinge 455. The forward end 410 thus rises above the frame 14, as illustrated. To lower the boom 200, the process is reversed and the hydraulic cylinders 320, 330 lower the travel height truss 400.

Considering FIGS. 3C and 3E, in the position shown there the boom 200 is in its rest or lowered position. The boom 200 is extended as far forward along frame 14 as possible. The travel height truss 400 on which the boom rests is also in its rest or lowered position. The lift cylinder 320 is fully retracted and the travel cylinder 330 is fully extended.

In the position illustrated in FIGS. 3D and 3F, the boom 200 is in an intermediate position between its rest or lowered position and its maximum extended position. Boom 200 has travelled along a conventional track (not illustrated for clarity) from its maximum forward position as shown in FIG. 3C toward the rear of frame 14. As compared to the position shown in FIGS. 3C and 3E, the travel cylinder 330 has remained fully extended but the lift cylinder 320 has extended from its previous fully retracted position, causing forward end 410 of travel height truss 400 to pivot to an essentially vertical orientation as shown in FIG. 3D. The combination of the movement of boom 200 and the vertical orientation of forward end 410 of travel height truss 400 raises boom 200 to a substantial height above trailer 10. As illustrated, boom 200 has an optional extension that is not been extended or unfolded.

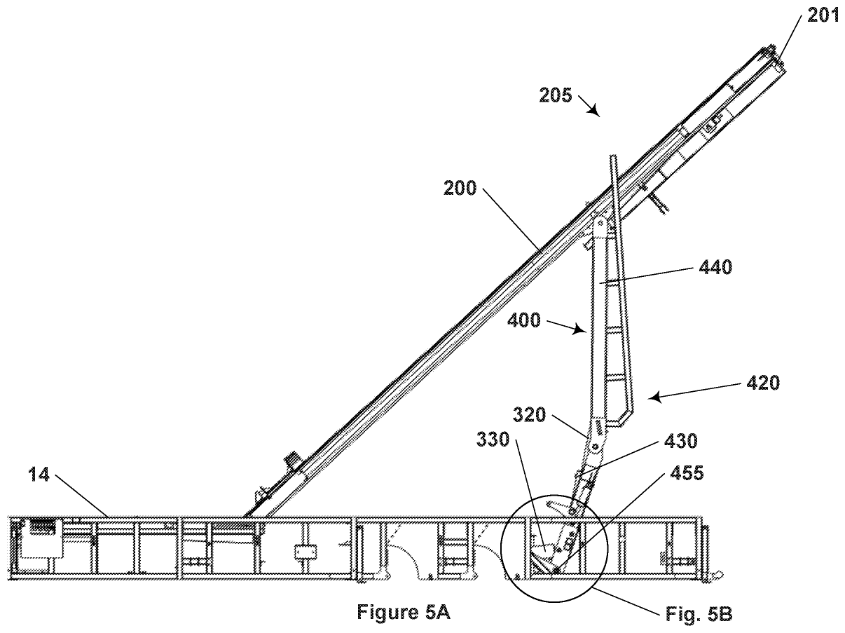

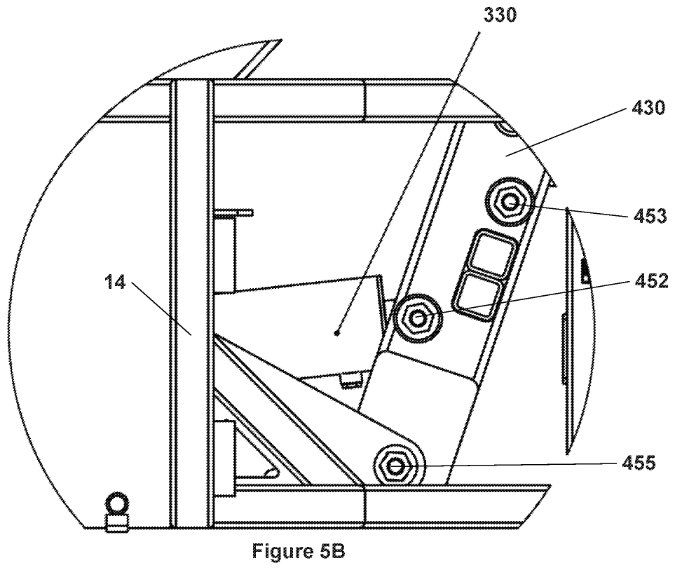

In the position illustrated in FIGS. 5A and 5B, the second portion 202 of boom 200 remains in the position it was in as described immediately above. In addition, the lift cylinder 320 has continued to extend, and in coordination with that extension the travel cylinder 330 has fully retracted. As opposed to the previous position, both inner frame 430 and outer frame 440 of travel height truss 400 are directed essentially vertically above the horizontal plane of frame 14. The combined motion causes boom 200 to rise vertically even further upward, while maintaining a desired distance from the rear of trailer 10 despite is increased height above trailer 10.

The description above describes the operation of a travel height assist truss 400 which was assumed to be manufactured as part of the original manufacture of trailer 10 and its associated loads and controls as described. However, a travel height truss according to the principles of the disclosure may be retrofitted onto previously manufactured equipment, such as the addition of boom 200 to a previously manufactured trailer 10.

Although specific embodiments have been illustrated and described herein, it will be appreciated by those of ordinary skill in the art that a variety of alternate and/or equivalent implementations may be substituted for the specific embodiments shown and described without departing from the scope of the present disclosure. This application is intended to cover any adaptations or variations of the specific embodiments discussed herein. Therefore, it is intended that this disclosure be limited only by the claims and the equivalents thereof.

What is claimed is:

1. A trailer having:
a frame;
a travel height truss secured to the frame; the travel height truss having an inner portion and an outer portion that are pivotally connected to each other;
a first hydraulic system connected to the travel height truss; and
a boom supported by the travel height truss, wherein the boom can translate along a length of the frame; further wherein the travel height truss configured, in combination with the first hydraulic system, to elevate the boom with respect to the frame; wherein the travel height truss can be further elevated above the frame by the first hydraulic system.

2. The trailer of claim 1, wherein the first hydraulic system includes first and second hydraulic cylinders.

3. The trailer of claim 15, wherein the first hydraulic cylinder is positioned between the frame and the inner portion of the travel height truss and the second hydraulic cylinder is positioned between the inner portion of the travel height truss and the outer portion of the travel height truss.

4. The trailer of claim 20, wherein the outer portion is pivotally attached to the boom.

5. The trailer of claim 1, wherein the outer portion is pivotally attached to a middle location of the boom.

6. The trailer of claim 1, wherein the outer portion of travel height truss may be elevated substantially above frame while the inner portion remains generally in place vertically.

7. The trailer of claim 1, wherein the outer portion can fold with respect to the inner portion.

8. A method of operating a trailer, the method comprising:
providing a trailer including:
a frame,
a travel height truss secured to the frame; the travel height truss having a outer portion and an inner portion that are pivotally connected to each other,
a first hydraulic system connected to the travel height truss, and
a boom supported by the travel height truss;
moving the boom from a rearward position to a forward position along a length of the frame; and
lifting the boom with the travel height truss.

9. The method of claim 15, wherein the outer portion is pivotally attached to a middle location of the boom.

10. The method of claim 8, wherein the boom is used for lifting or lowering an oil drilling pipe.

11. The method of claim 8, wherein during the step of lifting, the travel height truss unfolds.

12. The method of claim 8, wherein, during the step of lifting, the travel height truss becomes more linear.

13. The method of claim 8, wherein, during the step of lifting the outer portion of travel height truss is elevated substantially above frame while the inner portion remains generally in place vertically.

14. The method of claim 8, wherein the first hydraulic system includes first and second hydraulic cylinders.
